(19) United States
(12) Patent Application Publication
(10) Pub. No.: US 2018/0362884 A1
(43) Pub. Date: Dec. 20, 2018

(54) DISHWASHING DETERGENT COMPOSITIONS

(71) Applicant: RHODIA OPERATIONS, Paris (FR)

(72) Inventors: David V. DOBROWOLSKI, Robbinsville, NJ (US); Rajesh PATEL, Pennington, NJ (US)

(73) Assignee: RHODIA OPERATIONS, Paris (FR)

(21) Appl. No.: 16/012,874

(22) Filed: Jun. 20, 2018

Related U.S. Application Data
(60) Provisional application No. 62/522,237, filed on Jun. 20, 2017.

(51) Int. Cl. C11D 1/94

(52) U.S. Cl. CPC C11D 1/94; C11D 1/29

(57) ABSTRACT

Detergent compositions including: one or more sulfates selected from sodium laureth sulfate, sodium lauryl sulfate, and combinations thereof; disodium ricinoleamido MEA-sulfosuccinate; and one or more sulfobetaines.

### CROSS-REFERENCE TO RELATED APPLICATION

The present application claims the benefit of priority under 35 U.S.C. § 119(e) of U.S. Provisional Application Ser. No. 62/522,237, filed on Jun. 20, 2017, the entire disclosure of which is incorporated herein by reference.

### BACKGROUND

Hand dishwashing detergent compositions should have a good suds profile while providing good soil and grease cleaning and at the same time the composition should provide a pleasant washing experience, i.e, good feel on the user's hands during and after the wash and the composition should be easy to rinse.

Typically, hand dish formulations are formulated using amine oxides to provide a good suds profile with good soil and grease cleaning power. Both cocamidopropyl and lauryldimethylamine oxides are commonly used in these formulations due to their excellent foam boosting properties as well foam stability in the presence of oily soils. However, amine oxides are classified as very toxic to aquatic organisms and may cause long term adverse effects in the aquatic environment.

It is also well-known to formulate hand dish detergents with sulfate-containing surfactants, such as sodium lauryl sulfate (SLS) and sodium laureth sulfate (SLES), and non-ionic amine oxides. These detergents are typically formulated between 10% to as high as 38% solids. The premium top performing products are typically at the top end of the solids range and contain solvents, such as ethanol or propylene glycol, to reduce viscosity to below 1000 centipoise in order to make the product pourable. However, such solvents tend to reduce the performance of the detergent and are also cause for environmental concern.

As the world continues to examine and address the ecotoxicity of amine oxides and volatile organic solvent-based products that release volatile organic solvents into the atmosphere, there is a continued need to develop cost-effective compositions to replace such products.

### SUMMARY

The present disclosure provides compositions that are free of organic solvents and amine oxides that foam adequately in the presence of greasy soil and exhibit enhanced foam performance at reduced surfactant levels, making them suitable for use as liquid dish detergents.

### DETAILED DESCRIPTION

In general, compositions according to the present disclosure include one or more sulfates selected from sodium laureth sulfate, sodium lauryl sulfate, and combinations thereof; disodium ricinoleamido MEA-sulfosuccinate; and one or more sulfobetaines. The compositions produce adequate foam in the presence of greasy soil and also exhibit enhanced performance at reduced surfactant levels. Compositions of the present disclosure surprisingly out-performed industry benchmarks in a simulated plate count test even though the benchmarks are formulated at a higher solids level compared with compositions described herein.

Concentrated forms of the compositions can be diluted by a supplier prior to purchase by an end user or after purchase by the end user himself or a combination of both. In an embodiment, the diluted composition exhibits a viscosity of less than 1000 centipoise without the addition of non-aqueous solvents. In an embodiment, the composition further includes water.

In an embodiment, such compositions are diluted without any additional organic solvents, including volatile organic compounds (VOCs). In an embodiment, the composition is VOC-free. By the expressions “VOC-free composition” or “free of VOCs” it is meant that the composition of the disclosure is devoid of, i.e. does not contain (0%) any volatile organic compounds.

In an embodiment, the surfactant combination is present in the detergent composition in an amount ranging from about 15 wt % to about 65 wt % by total weight of the detergent composition.

In an embodiment, detergent compositions of the present disclosure include disodium ricinoleamido MEA-sulfosuccinate in an amount ranging from about 0.5 wt % to about 2.5 wt % based upon the total weight of the composition.

In an embodiment, detergent compositions of the present disclosure include one or more sulfates and one or more sulfobetaines in a ratio ranging from 1:1 to 10:1 total sulfates to total sulfobetaines.

In an embodiment, the one or more sulfobetaines (INCI: sultaines) are selected the sulfobetaines of Formula I; the amido sulfobetaines of Formula II; and combinations thereof:

R¹—N⁺(CH₃)₂—CH₂CH(OH)CH₂SO₃— Formula I

R¹—CO—NH—(CH₂)₃—N⁺(CH₃)₂—CH₂CH(OH)CH₂SO₃— Formula II

wherein R¹ is a saturated or unsaturated C6-22 alkyl residue, preferably C8-18 alkyl residue, in particular a saturated C10-16 alkyl residue, for example a saturated C12-14 alkyl residue. In an embodiment, the one or more sulfobetaines are selected from (designated in accordance with INCI): Cocamidopropyl Hydroxysultaine, Coco Hydroxysultaine, Coco Sultaine, Erucamidopropyl Hydroxysultaine, Lauryl Hydroxysultaine, Lauryl Sultaine, Oleamidopropyl Hydroxysultaine, Tallow amidopropyl Hydroxysultaine, and combinations thereof.

Optionally, the detergent compositions described herein include one or more additives selected from builders, chelants, conditioning polymers, cleaning polymers, surface modifying polymers, soil flocculating polymers, structurants, emmolients, humectants, skin rejuvenating actives, enzymes, carboxylic acids, scrubbing particles, bleach and bleach activators, perfumes, malodor control agents, pigments, dyes, opacifiers, beads, pearlescent particles, microcapsules, organic and inorganic cations, diamines, antibacterial agents, preservatives, pH adjusters, buffering means, and combinations thereof.

In an embodiment, the pH of the detergent is adjusted to between 3 and 14, more preferably between 4 and 13, more preferably between 6 and 12 and most preferably between 8 and 10. The pH of the detergent can be adjusted using pH modifying ingredients known in the art.

Other aspects of the disclosure are directed to methods of washing dishware with a composition of the present disclosure. In an embodiment, such methods include the step of delivering the composition, preferably in liquid form, onto the dishware surface, either in diluted or neat form and rinsing or leaving the composition to dry on the surface without rinsing the surface.

By “in its neat form”, it is meant herein that the composition is applied directly onto the surface to be treated and/or onto a cleaning device or implement such as a dish cloth, a sponge or a dish brush without undergoing any dilution (immediately) prior to the application. The cleaning device or implement is preferably wet before or after the composition is delivered to it. By “rinsing”, it is meant herein contacting the dishware cleaned using a process according to the present disclosure with substantial quantities of appropriate solvent, typically water, after the step of applying the liquid composition herein onto the dishware. By “substantial quantities”, it is meant usually about 1 to about 10 liters.

In an embodiment, compositions described herein are further diluted by the user prior to washing soiled dishware. Soiled dishware are contacted with an effective amount, typically from about 0.5 ml to about 20 ml (per about 25 dishes being treated), preferably from about 3 ml to about 10 ml, of the detergent composition, preferably in liquid form, of the present invention diluted in water. The actual amount of detergent composition used will be based on the judgment of user, and will typically depend upon factors such as the particular product formulation of the composition, including the concentration of active ingredients in the composition, the number of soiled dishes to be cleaned, the degree of soiling on the dishes, and the like. Generally, from about 0.01 ml to about 150 ml, preferably from about 3 ml to about 40 ml of a liquid detergent composition of the disclosure is combined with from about 2000 ml to about 20000 ml, more typically from about 5000 ml to about 15000 ml of water in a sink having a volumetric capacity in the range of from about 1000 ml to about 20000 ml, more typically from about 5000 ml to about 15000 ml. The soiled dishes are immersed in the sink containing the diluted compositions then obtained, where contacting the soiled surface of the dish with a cloth, sponge, or similar article cleans them. The cloth, sponge, or similar article may be immersed in the detergent composition and water mixture prior to being contacted with the dish surface, and is typically contacted with the dish surface for a period of time ranged from about 1 to about 10 seconds, although the actual time will vary with each application and user. The contacting of cloth, sponge, or similar article to the dish surface is preferably accompanied by a concurrent scrubbing of the dish surface.

Another method of the present disclosure includes immersing the soiled dishes into a water bath or held under running water without any liquid dishwashing detergent. A device for absorbing liquid dishwashing detergent, such as a sponge, is placed directly into a separate quantity of undiluted liquid dishwashing composition for a period of time typically ranging from about 1 to about 5 seconds. The absorbing device, and consequently the undiluted liquid dishwashing composition, is then contacted individually to the surface of each of the soiled dishes to remove said soiling. The absorbing device is typically contacted with each dish surface for a period of time range from about 1 to about 10 seconds, although the actual time of application will be dependent upon factors such as the degree of soiling of the dish. The contacting of the absorbing device to the dish surface is preferably accompanied by concurrent scrubbing.

Alternatively, the device may be immersed in a mixture of the hand dishwashing composition and water prior to being contacted with the dish surface, the concentrated solution is made by diluting (or further diluting) the hand dishwashing composition with water in a small container that can accommodate the cleaning device at weight ratios ranging from about 95:5 to about 5:95, preferably about 80:20 to about 20:80 and more preferably about 70:30 to about 30:70, respectively, of hand dishwashing liquid:water depending upon the user habits and the cleaning task.

While specific embodiments are discussed, the specification is illustrative only and not restrictive. Many variations of this disclosure will become apparent to those skilled in the art upon review of this specification.

The present disclosure will further be described by reference to the following examples. The following examples are merely illustrative and are not intended to be limiting. Unless otherwise indicated, all percentages are by weight of the total composition.

### Example 1

Super Concentrate (A) was made containing the following:

| Super Concentrate (A) | wt % |
|---|---|
| Sodium Laureth Sulfate (2EO) | 42 |
| Lauramidopropyl Hydroxysultaine | 14 |
| Disodium Ricinoleamido MEA-Sulfosuccinate | 2 |
| NaCl | 5 |
| DI H₂O | 37 |

This mixture resulted in a surfactant concentrate in the lamellar phase exhibiting the following physical properties:

### Viscosity=7,000 cPs

### Solids=63.0%

pH=7.12

Super Concentrate (A) was then further diluted down into the percent solids range of a typical hand dish formulation as follows:

| Formulation (A) | wt % |
|---|---|
| Super Concentrate (A) | 38.6 |
| DI H₂O | 61.4 |

This dilution resulted in a formulation in the micellar region and had the following properties:

### % Solids=23.3

Viscosity (centipoise)=670

The viscosity results for Formulation (A) are unexpected as it falls in the typical range of most hand dish liquids but contains no solvents.

### Example 2

Super Concentrate (B) was made containing the following:

| Super Concentrate (B) | wt % |
|---|---|
| Sodium Laureth Sulfate (2EO) | 42 |
| Lauramidopropyl Hydroxysultaine | 14 |
| NaCl | 5 |
| DI H₂O | 39 |

This mixture resulted in a surfactant concentrate in the lamellar phase exhibiting the following physical properties:

### Viscosity=7,000 cPs

### Solids=63.0%

pH=7.12

Super Concentrate (B) was then further diluted down into the percent solids range of a typical hand dish formulation as follows:

| Formulation (B) | wt % |
|---|---|
| Super Concentrate (B) | 33.8 |
| DI H₂O | 66.2 |

This dilution resulted in a formulation in the micellar region and had the following properties:

### % Solids=20.6

Viscosity (centipoise)=19,000

In comparison with Super Concentrate (A), this mixture omitted disodium ricinoleamido MEA-sulfosuccinate. The viscosity of 19,000 centipoise is what would be expected for such types of mixtures. In this example, a solvent is needed to reduce the viscosity into the range of most dish detergent formulations (for example, below 1000 centipoise).

### Example 3

Performance Testing

ASTM method number D4009-92 provides guidelines to measure the foam stability of hand-dish formulations in the presence of artificially applied food soils. In the ASTM test, soiled dinner plates are washed by hand in solutions of hand dishwashing detergents under standardized conditions until an end-point of near-disappearance is reached. The ASTM method is used to evaluate product performance, however it is time consuming, cumbersome and the results are often operator dependent.

Here, we employed a more efficient way to evaluate foam stability in the presence of simulated food soil. The present technique yields results with trends that correlate closely to those obtained from the ASTM method. The simulated method scales the amount of soil to be equal to that for an equivalent number of plates used in actual plate count testing to a 20 mL test volume. In particular, the foam stability was evaluated at 47° C. in 100 mL graduated cylinders using 20 mL of a 0.10% test solution of the product. The amount of soil added to each cylinder was scaled to be equal to that for an equivalent number of plates used in actual ASTM testing. For example, 0.18 grams of soil added to 20 mL of test solution is equal to the amount of soil for 6 dinner plates used in the ASTM test. The amounts added to a 20 mL test volume and theoretical number of equivalent is shown in Table 1.

TABLE 1

| | Soil (grams) | | | | | |
|---|---|---|---|---|---|---|
| | 0.00 | 0.09 | 0.18 | 0.27 | 0.36 | 0.45 |
| Plate Equivalent | 0 | 3 | 6 | 9 | 12 | 15 |

In this test the foam is generated manually by inverting the cylinder and its contents upside down and back again at a fixed rate (20 cycles/sec) for 20 cycles. Foam measurements are taken as the total contents volume [milliliters (foam)+milliliters (solution)] at the point where the foam starts to become dense. Simulated plate count measurements (SP) are made using an extrapolated calculation based on the following equation:

SP=[(y−(x/2))/(y−(z/3))]+C

where:
x=Initial foam height at zero grams of soil;
y=Foam height value of the top of the range where the volume decreased by half of the initial value;
z=Foam height value at the bottom of the range where the volume decreased by half of the initial value; and
C=Value for the number of equivalent plates at the top of the ½ volume range.

Formulation (A) was tested and compared to two market product dish detergents using the simulated plate count test. These products were chosen as benchmarks as they are formulated within the same pH and solids range as Formulation (A) (properties shown in Table 2).

TABLE 2

| | Viscosity | | | Equivalent |
|---|---|---|---|---|
| Dish Detergent | (centipoise) | pH | % Solids | Plates |
| Great Value ™ | 505 | 7.81 | 33.21 | 8 |
| Palmolive ® | 406 | 7.72 | 26.70 | 12 |
| Formulation (A) | 670 | 7.12 | 23.30 | 15 |

The test yielded simulated plate count numbers as follows: Great Value™ (8 Equivalent plates), Palmolive® (12 Equivalent Plates), and Formulation (A) (15 Equivalent Plates). These results show Formulation (A) to be adequate for use as a dish detergent as it out-performed the two industry benchmarks. These results are surprising since both of the commercially-available consumer products are formulated at a higher solids level compared to Formulation (A).

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein.

We claim:

1. A detergent composition comprising:
a. one or more sulfates selected from the group consisting of sodium laureth sulfate, sodium lauryl sulfate, and combinations thereof;
b. disodium ricinoleamido MEA-sulfosuccinate; and
c. one or more sulfobetaines.

2. The detergent composition of claim 1 comprising a ratio of one or more sulfates to one or more sulfobetaines ranging from 1:1 to 10:1.

3. The detergent composition of claim 1 comprising disodium ricinoleamido MEA-sulfosuccinate in an amount ranging from about 0.5 wt % to about 2.5 wt % based upon the total weight of the composition.

4. The detergent composition of claim 1, wherein the one or more sultaines are selected from the group consisting of Cocamidopropyl Hydroxysultaine, Coco Hydroxysultaine, Coco Sultaine, Erucamidopropyl Hydroxysultaine, Lauryl Hydroxysultaine, Lauryl Sultaine, Oleamidopropyl Hydroxysultaine, Tallow amidopropyl Hydroxysultaine, and combinations thereof.

5. The detergent composition of claim 1, further comprising water.

6. The detergent composition of claim 1, wherein the composition is VOC-free.

7. A detergent composition comprising a surfactant combination comprising:
a. one or more sulfates selected from sodium laureth sulfate, sodium lauryl sulfate, and combinations thereof;
b. disodium ricinoleamido MEA-sulfosuccinate; and
c. one or more sulfobetaines,
wherein the surfactant combination is present in the detergent composition in an amount ranging from about 15 wt % to about 65 wt % by total weight of the detergent composition.

8. A method of manually washing dishware comprising delivering a composition of claim 1 directly onto a dishware surface or onto a cleaning implement and using the cleaning implement to clean a dishware surface.

9. The method of claim 8, wherein the composition is in a diluted form.
